(19) United States
(12) Patent Application Publication
(10) Pub. No.: US 2009/0147030 A1
(43) Pub. Date: Jun. 11, 2009

(54) LCD Driver IC and Method for Operating the Same

(76) Inventors: Woo Jae Choi, Dongjak-gu (KR); Jong Kee Kim, Jangan-gu (KR); Mi Youn Kim, Suwon-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/259,600

(22) Filed: Oct. 28, 2008

(30) Foreign Application Priority Data
Dec. 5, 2007 (KR) 10-2007-0125438

(51) Int. Cl. G09G 5/10

(52) U.S. Cl. 345/690

(57) ABSTRACT

A liquid crystal display (LCD) driver integrated circuit (IC) is provided. The LCD driver IC, according to an embodiment, can include gamma reference buffers built in respective source drivers, where an output connection resistance is provided for connecting an output of a gamma reference buffer of one source driver to an output of a gamma reference buffer of another source driver.

### CROSS-REFERENCE TO RELATED APPLICATION

The present application claims the benefit under 35 U.S.C. §119 of Korean Patent Application No. 10-2007-0125438, filed Dec. 5, 2007, which is hereby incorporated by reference in its entirety.

### BACKGROUND

FIG. 1 is a concept view showing a driving method of a liquid crystal display (LCD) of the related art.

As shown in FIG. 1, according to a panel driving method in the LCD of the related art, gamma reference buffers (GMA), which provide gamma reference voltages to each chip on the panel, are typically arranged on a control printed circuit board (PCB).

In certain cost-reduced panels, the gamma reference voltages are connected using the data/source lines of thin film transistors (TFT) on the panel glass, so resistance between chips becomes great.

A voltage (I×R) drop is generated by the resistance between the chips and the current flowing on R-string of the chips. The gamma reference, which becomes the reference voltage in each chip, becomes thereby different, so the LCD does not operate properly.

In order to solve this problem, there is a method to insert the existing gamma reference buffers from the control PCB to each of the chips (i.e. the GMAs are provided built-in with the chips for the panel). In this case, the IR-drop described above can be avoided since the current does not flow on the control PCB. However, according to this method, offsets of the gamma reference buffers for each built-in chip are to be the same, which can be a disadvantage.

If the offsets of the gamma reference buffers become different, the gamma reference voltages, which are the reference voltages in each chip, also become different. The offsets are shown through outputs of source drivers. Owing to the different offsets in each chip, on a screen driven by several source drivers, the properties of an image quality among blocks become different. This is referred to as a block dim effect.

### BRIEF SUMMARY

For price competitiveness, a Chip-On-Film (COF) or a Tape Carrier Package (TCP), which occupies 60% of a current driver IC can be removed and replaced with a less expensive packaging technology. For example, a Chip-On-Glass (COG) package can be utilized. In this case, a Flexible PCB (FPC) can be used for control board, driver power, and control signal connections.

For achieving optimal price competitiveness, as an area of the FPC reduces, as described above, gamma reference voltages can be connected per chip with a material forming a data/source line of a thin film transistor TFT on a glass.

Due to a large resistance between chips, a method using each gamma reference buffer for each chip is used. However, each gamma reference buffer should have the same error characteristic. Generally, the error characteristic of the gamma reference buffer is about ±15 mV until now. When operating a panel with a driver having such an error characteristic, the voltage of the gamma reference buffer may be different for each chip, thereby creating a difference between inter-chip blocks.

According to an embodiment of the present invention, an LCD Driver IC is provided capable of reducing errors in gamma reference voltage between chips and a method for operating the same. Accordingly, errors causing differences between the blocks of the LCD can be reduced or mitigated.

In an embodiment, a LCD driver IC can comprise: gamma reference buffers built in respective source drivers; and an output connection resistance connecting outputs of the gamma reference buffers of the respective source drivers.

In another embodiment, there is provided a method for operating an LCD driver IC including gamma reference buffers built in respective source drivers, the method utilizing the connection of the outputs of the gamma reference buffers of the respective source drivers to reduce errors in inter-chip blocks.

### BRIEF DESCRIPTION OF THE DRAWINGS

FIG. 1 is a concept view showing a driving method of a liquid crystal display (LCD) of the related art.

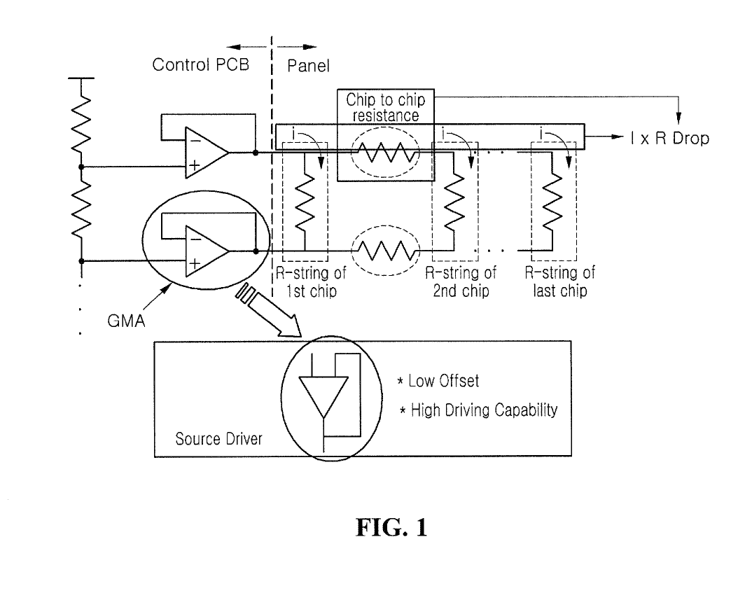

FIG. 2 shows a diagram of a thin film transistor (TFT)-liquid crystal display (LCD) to which an LCD driver IC according to an embodiment can be applied.

FIG. 3 is a schematic showing connection of the outputs of gamma reference buffers of source drivers in a liquid crystal display (LCD) driver integrated circuit (IC) according to an embodiment of the present invention.

FIG. 4 shows a schematic of an experimental set-up illustrating the effect of an LCD driver IC according to an embodiment of the present invention.

### DETAILED DESCRIPTION

Hereinafter, embodiments of a liquid crystal display (LCD) driver integrated circuit (IC) and a method for operating the same will be described with reference to the accompanying drawings.

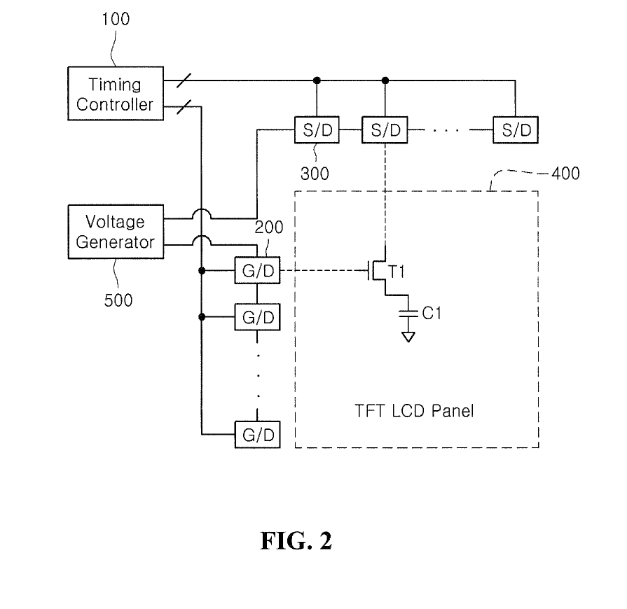

FIG. 2 illustrates an arrangement of a thin film transistor (TFT)-liquid crystal display (LCD) to which an LCD driver IC according to an embodiment can be applied. However, embodiments of the present invention can be applied to other LCD configurations.

Referring to FIG. 2, the TFT-LCD can include a plurality of gate drivers G/D 200 driven by a timing controller 100 to sequentially drive gate lines of a liquid crystal panel 400, and a plurality of source drivers S/D 300 driven by the timing controller 100 to drive source lines of the liquid crystal panel 400 and to allow the liquid crystal panel 400 to display data. In addition, the TFT-LCD can include a voltage generator 500 generating the voltages requested by the system.

In the liquid crystal panel 400, unit pixels including a liquid crystal capacitor C1 and a switching thin film transistor T1 are arranged in a matrix formation, wherein sources of each thin film transistor T1 are connected to source lines driven by source drivers 300, and gates of each of thin film transistor T1 are connected to gate lines drive by gate drivers 200.

In operation, the TFT-LCD sequentially drives the gate line corresponding to each gate driver 200 using the timing controller 100, and the source driver 300 applies an analog signal to the source line by inputting data to display the data. The data can be provided by the timing controller 100.

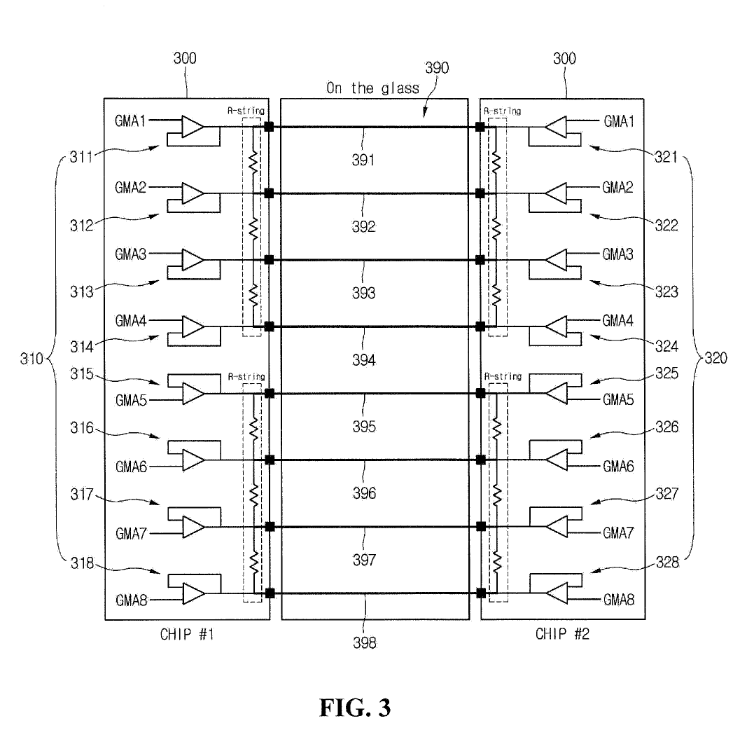

FIG. 3 shows an LCD driver IC according to an embodiment of the present invention. In particular, FIG. 3 illustrates the connection of the outputs of gamma reference buffers in a source driver 300 according to an embodiment of the present invention.

Referring to FIG. 3, the LCD driver IC can include gamma reference buffers 310 and 320 built in respective source drivers 300, and an output connection resistance 390 connecting outputs of the gamma reference buffers 310 and 320 for the different source drivers 300.

In an embodiment, the output connection resistance 390 can connect outputs of the gamma reference buffers with corresponding gamma reference buffers for each chip. For example, an output of a first gamma reference buffer 311 of a first chip CHIP #1 can be connected to an output of a first gamma reference buffer 321 of a second chip CHIP #2 using a first resistance connector 391. In a specific embodiment, the first chip CHIP #1 can include the first gamma reference buffer 311, a second gamma reference buffer 312, a third gamma reference buffer 313, a fourth gamma reference buffer 314, a fifth gamma reference buffer 315, a sixth gamma reference buffer 316, a seventh gamma reference buffer 317, and an eighth gamma reference buffer 318; and the second chip CHIP #2 can include the first gamma reference buffer 321, a second gamma reference buffer 322, a third gamma reference buffer 323, a fourth gamma reference buffer 324, a fifth gamma reference buffer 325, a sixth gamma reference buffer 326, a seventh gamma reference buffer 327, and an eighth gamma reference buffer 328. Therefore, the output of the second gamma reference buffer 312 of the first chip CHIP #1 can be connected to the output of the second gamma reference buffer 322 of the second chip CHIP #2 using a second resistance connector 392, the output of the second gamma reference buffer 312 of the first chip CHIP #1 can be connected to the output of the second gamma reference buffer 322 of the second chip CHIP #2 using a second resistance connector 392, the output of the third gamma reference buffer 313 of the first chip CHIP #1 can be connected to the output of the third gamma reference buffer 323 of the second chip CHIP #2 using a third resistance connector 393, the output of the fourth gamma reference buffer 314 of the first chip CHIP #1 can be connected to the output of the fourth gamma reference buffer 324 of the second chip CHIP #2 using a fourth resistance connector 394, the output of the fifth gamma reference buffer 315 of the first chip CHIP #1 can be connected to the output of the fifth gamma reference buffer 325 of the second chip CHIP #2 using a fifth resistance connector 395, the output of the sixth gamma reference buffer 316 of the first chip CHIP #1 can be connected to the output of the sixth gamma reference buffer 326 of the second chip CHIP #2 using a sixth resistance connector 396, the output of the seventh gamma reference buffer 317 of the first chip CHIP #1 can be connected to the output of the seventh gamma reference buffer 327 of the second chip CHIP #2 using a seventh resistance connector 397, the output of the eighth gamma reference buffer 318 of the first chip CHIP #1 can be connected to the output of the eighth gamma reference buffer 328 of the second chip CHIP #2 using an eighth resistance connector 398.

However, embodiments are not limited to eight reference buffers for each chip. For example, fewer than eight or more than eight gamma reference buffers can be included in each source driver 300.

In the embodiment illustrated by FIG. 3, the output connection resistance 390 can be provided as a line resistance. However, the output connection resistance 390 is not limited thereto.

In a further embodiment, a switch (not shown) controlling a time connecting outputs of the gamma reference buffers of the source drivers can be included as part of the output connection resistance 390.

According to an embodiment, outputs of two gamma reference buffers 310 and 320 of their respective source drivers can be connected using an output connection resistance 390 on the glass panel. In addition, the gamma reference buffers 310 of the first chip CHIP #1 can be connected equivalent to an R-string, and the gamma reference buffers 320 of the second chip CHIP #2 can be connected equivalent to an R-string.

Each gamma reference buffer has a gamma reference voltage input to the source drivers (GMA1, GMA2, GMA3, GMA4, GMA5, GMA6, GMA7, and GMA8 for the eight reference buffers shown in FIG. 3). However, in other embodiments the number of the gamma reference voltages can be different. According to an embodiment, the gamma reference voltages (GMA1 to GMA8) for each gamma reference buffer in each chip can be the same. For example, GMA1, the voltages input to the first gamma reference buffers in the first and second chips can be the same.

According to embodiments of the present invention, the concept of the LCD driver IC is to connect the outputs of the gamma reference buffers of one source driver to the outputs of the gamma reference buffers of another source diver through an output connection resistance. By applying this configuration, it is possible to minimize voltage differences of the outputs of the gamma reference buffers due to offsets. The outputs of gamma reference buffers of additional source drivers can also be connected using additional output connection resistance elements.

With the embodiment, the difference of the gamma reference buffers (the reference voltage between two chips) in a liquid crystal screen can be minimized, making it possible to display a more uniform image.

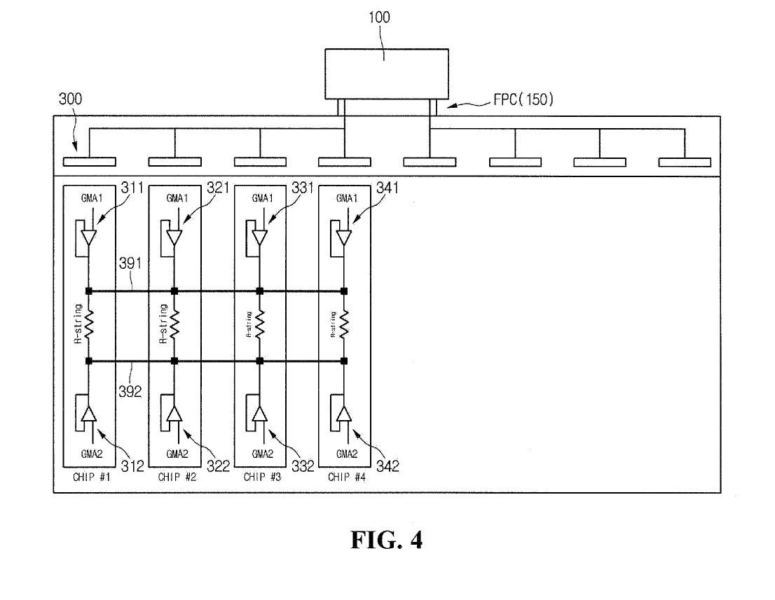

FIG. 4 is an experimental concept view illustrating the effect of a LCD driver IC according to an embodiment of the present invention.

FIG. 4 shows a simulation confirming certain effects of the above described embodiment. In FIG. 4, reference numeral 100 refers to a timing controller, and reference numeral 150 refers to a flexible PCB (FPC) for connecting power and signal lines between a timing controller 100 and a source driver 300.

Referring to FIG. 4, eight source drivers 300 are mounted on a panel using a chip-on-glass (COG) method, wherein the gamma reference voltages GMA1 and GMA2 are identically input to the respective source drivers. There may be several voltages, as described above.

In order to acknowledge the effects of the embodiment, the outputs from the gamma reference buffer in the respective source drivers are connected by a connection resistor. For example, a first gamma reference buffer 311 of the first chip, a first gamma reference buffer 321 of the second chip, a first gamma buffer 331 of the third chip, and a first gamma buffer 341 of the fourth chip can be connected by the first connection resistor 391. Additional gamma buffers for additional chips for the remaining chip slots of FIG. 4 are not shown, but they may be connected by the first connection resistor 391 in the same manner as the connection of the first gamma reference buffers of the four source driver chips (CHIP #1, CHIP#2, CHIP#3, and CHIP #4).

Also, the second gamma buffer 312 of the first chip, the second gamma buffer 322 of the second chip 322, the second gamma buffer 322 of the third chip, and the second gamma buffer 342 of the fourth chip can be connected by the second connection resistor 392. Additional gamma buffers for additional chips for the remaining chip slots of FIG. 4 are not shown, but they may be connected by the second connection resistor 392 in the same manner as the connection of the first gamma reference buffers of the four source driver chips (CHIP #1, CHIP#2, CHIP#3, and CHIP #4).

According to an implementation, it is assumed that GMA1 voltage is 9.5V and GMA2 voltage is 5.0V. In particular, the same GMA1 and GMA2 voltages should be input to the corresponding gamma buffers for each source driver. However, as described with respect to the related art, the GMA1 and GMA2 voltages are often different for each source driver. In the simulating experiment to illustrate an embodiment of the present invention, the input of each source driver is arranged to have a difference of no more than 30 mV. For example, with a GMA1 voltage of 9.5 V, the source drivers are applied with an input voltage of 9.48V˜9.51V. Table 1 provides the input voltages applied to the simulation set-up and the resulting output voltage for each source driver upon application of the subject connection resistance.

TABLE 1

| | GMA1/GMA2 | Embodiment: GMA1/GMA2 |
|---|---|---|
| | Input voltage(in) | Voltage(out) |
| CHIP #1 | 9.48 V/5.01 V | 9.480 V/4.992 V |
| CHIP #2 | 9.51 V/5.02 V | 9.485 V/4.990 V |
| CHIP #3 | 9.49 V/4.99 V | 9.488 V/4.986 V |
| CHIP #4 | 9.50 V/4.98 V | 9.489 V/4.980 V |

Table 1 indicates the input voltage of GMA1 and GMA2 of each source driver for CHIP #1, CHIP #2, CHIP #3, and CHIP #4, and the voltage GMA1 and GMA1 available from each source driver when the embodiment is applied.

When the embodiment is not applied, this input voltage is output as it is, thereby causing the difference of 30 mV between different source drivers.

However, it can be appreciated that when the embodiment is applied, the GMA1 and GMA2 voltages of the respective source driver have a maximum output error of 6 mV (as shown between CHIP #3 and CHIP #4:: 4.986V˜4.980V).

In summary, by utilizing the resistance connection according to an embodiment of the present invention, the error characteristic in the output of the gamma reference buffer can be reduced to 6 mV.

With the liquid crystal display (LCD) driver integrated circuit (IC) and the method for operating the same, the error (block dim) caused between the inter-chip blocks of the LCD can be reduced through using the connection of the inter-chip gamma reference voltage.

Also, embodiments of the present invention can be very advantageous in price competitiveness without needing to have the gamma buffer on the control board as provided by a conventional method where the gamma reference buffers are installed on the control board.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid crystal display (LCD) driver integrated circuit (IC), comprising:
a plurality of gamma reference buffers disposed in each source driver chip of the LCD; and
output connection resistance connecting outputs of the plurality of gamma reference buffers for the source driver chips.

2. The LCD driver IC according to claim 1, wherein the output connection resistance comprises line resistance.

3. The LCD driver IC according to claim 2, further comprising:
a switch controlling a time taken when the outputs of the gamma reference buffers are connected on the output connection resistance.

4. The LCD driver IC according to claim 3, wherein the output connection resistance connects the outputs of one of the plurality of the gamma reference buffers of one of the source driver chips with a corresponding one of the plurality of gamma reference buffers of another of the source driver chips.

5. The LCD driver IC according to claim 2, wherein the LCD comprises a liquid crystal panel, wherein the line resistance is disposed on the liquid crystal panel.

6. The LCD driver IC according to claim 1, further comprising:
a switch controlling a time taken when the outputs of the gamma reference buffers are connected on the output connection resistance.

7. The LCD driver IC according to claim 1, wherein the output connection resistance connects the outputs of one of the plurality the gamma reference buffers of one of the source driver chips with a corresponding one of the plurality of gamma reference buffers of another of the source driver chips.

8. The LCD driver IC according to claim 1, wherein the LCD comprises a liquid crystal panel, wherein the output connection resistance is disposed on the liquid crystal panel.

9. A method for operating a liquid crystal display (LCD) driver integrated circuit (IC), comprising:
applying reference voltages to source driver chips, wherein the LCD driver IC comprises gamma reference buffers built in respective source driver chips, and wherein outputs of the gamma reference buffers of one of the respective source drivers are connected to outputs of the gamma reference buffers of another of the respective source drivers.

10. The method for operating the LCD driver IC according to claim 9, wherein the outputs of the gamma reference buffers of the one of the respective source drivers are connected to the outputs of the gamma reference buffers of the another of the respective source drivers through output connection resistance.

11. The method for operating the LCD driver IC according to claim 10, wherein the output connection resistance comprises line resistance.

12. The method for operating the LCD driver IC according to in claim 11, wherein the LCD driver IC further comprises a switch on the output connection resistance to control a time connecting the outputs of the gamma reference buffers of the respective source drivers.

13. The method for operating the LCD driver IC according to claim 11, wherein the output connection resistance connects the outputs of one of the gamma reference buffers of the one of the respective source drivers to a corresponding one of the gamma reference buffers of each of the other respective source drivers.

14. The method for operating the LCD driver IC according to claim 11, wherein the LCD comprises a liquid crystal panel, wherein the output connection resistance is disposed on the liquid crystal panel.

15. The method for operating the LCD driver IC according to claim 10, wherein the LCD driver IC further comprises a switch on the output connection resistance to control a time connecting the outputs of the gamma reference buffers of the respective source drivers.

16. The method for operating the LCD driver IC according to claim 10, wherein the output connection resistance connects the outputs of one of the gamma reference buffers of one of the respective source drivers to a corresponding one of the gamma reference buffers of each of the other respective source drivers.

17. The method for operating the LCD driver IC according to claim 10, wherein the LCD comprises a liquid crystal panel, wherein the output connection resistance is disposed on the liquid crystal panel.
